(19) United States
(12) Patent Application Publication
(10) Pub. No.: US 2023/0159224 A1
(43) Pub. Date: May 25, 2023

(54) COMBINATION SET OF ECO-FRIENDLY ECYCLING BEVERAGE CONTAINER

(71) Applicants: Dong Ju KIM, Seoul (KR); Woo-Hyun KIM, Seoul (KR)

(72) Inventors: Dong Ju KIM, Seoul (KR); Woo-Hyun KIM, Seoul (KR)

(21) Appl. No.: 17/910,547

(22) PCT Filed: Feb. 15, 2022
(86) PCT No.: PCT/KR2022/002237

§ 371 Date: Sep. 9, 2022

(30) Foreign Application Priority Data
Feb. 15, 2021 (KR) 10-2021-0019820

(51) Int. Cl. B65D 23/08; B65D 8/00; B65D 65/46; B65D 23/10; B65D 71/00

(52) U.S. Cl. CPC B65D 23/08; B65D 15/02; B65D 65/466; B65D 23/104; B65D 71/00

(57) ABSTRACT

A combination set of eco-friendly recycling beverage container includes a container unit and a recycling storage unit. The container unit includes a soft part that has softness that folds and bends more easily than plastic or glass and stores a beverage therein, an inlet support part coupled around a beverage outlet at an upper end of the soft part, and a bottom support part coupled to a lower end of the soft part. The recycling storage unit is configured to accommodate and bind the container unit, the recycling storage unit having a multi-stage overlapping structure in which an overall height is reduced depending on a degree of reduced amount of the beverage contained in the container unit.

### TECHNICAL FIELD

The present disclosure relates to a combination set of eco-friendly recycling beverage container, which is capable of, by replacing PET (polyethylene terephthalate) of the beverage container with a soft material such as eco-friendly vinyl that is easy to decompose naturally, significantly reducing the use of PET that is an environmental pollutant, making it easier to store or trash the container by reducing the entire volume of the container as the amount of the beverage in the container decreases due to the consumption of the beverage, and preventing insipidness phenomenon during storage in the case that the beverage in the container is beer or carbonated drink.

### BACKGROUND

Commercially available beverage storage containers include aluminum cans, paper packs, glass bottles, and PET bottles, and the PET bottles are mainly used for large capacity storage.

However, the above storage containers are inconvenient to store in a refrigerator or the like at home because the size of the container cannot be reduced even when the contents therein are reduced by drinking a part of the beverage, and to trash the container even when the contents therein are all consumed due to its large volume.

Further, when the beverage in the container is beer or carbonated drink and the remaining beverage is stored, the unique taste changes during the storage process since insipidness phenomenon (carbonic acid emission) occurs due to the increase in empty space inside the container.

In addition, the PET bottles, which are spotlighted as a large-capacity storage container due to their relatively low manufacturing cost and light-weight, are pointed out as an environmental pollution factor, and thus their use should be reduced.

As such, it is difficult to decrease the sizes of beverage containers such as PET bottles currently used in the market even though the contents are reduced, which causes inconvenience in the storage or disposal process, and it is difficult to prevent the insipidness phenomenon. In addition, there is a problem that they cause environmental pollution due to the composition of the container.

### SUMMARY

In order to solve the above problems, the present disclosure reduces the inconvenience in storage and disposal process by allowing the size of the container to be reduced in accordance with the decrease of the contents in the container, while preventing the increase in empty space inside the container to suppress insipidness phenomenon, and reduces the use of environmental pollutants by using environmentally degradable materials instead of PET.

In accordance with an embodiment of the present disclosure, there is provided a combination set of eco-friendly recycling beverage container, the combination set including: a container unit including a soft part that folds and bends with greater softness than softness of plastic or glass and stores a beverage therein, an inlet support part coupled around a beverage outlet at an upper end of the soft part, and a bottom support part coupled to a lower end of the soft part; and a recycling storage unit configured to accommodate and bind the container unit, the recycling storage unit having a multi-stage overlapping structure in which an overall height is reduced depending on a degree of reduced amount of the beverage contained in the container unit, wherein the soft part is formed of a biomass material that is naturally decomposable, and a fitting flange of an enlarged structure having a fitting protrusion is formed at a lower end of the inlet support part, and a soft finger ring is provided at a position of a lower outer surface of the soft part to prevent inconvenience caused by the bending of the soft part in a process of tilting the container unit to pour the beverage, wherein a plurality of deformation preventing rods are coupled to the soft part in a vertical structure at a predetermined interval along an outer surface of the soft part to prevent the container unit from collapsing or bending due to a flexibility of the soft part when the container unit containing the beverage is provided alone, and wherein the plurality of deformation prevention rods are detachable from the outer surface of the soft part.

The biomass material of the soft part may be a mixture of material components including poly lactic acid (PLA), polybutylene succinate (PBS), polybutylene adipate-co-terephthalate (PBAT), and inorganic compound, and the inlet support part and the bottom support part may be formed of polyethylene terephthalate (PET) and the deformation prevention rods are formed of a plastic material.

The recycling storage unit may have a single-stage or multi-stage structure with top and bottom opened, and may be formed of a material of PET.

An upper end of the recycling storage unit may be fitted onto the fitting protrusion of the inlet support part.

The recycling storage unit of the multi-stage structure may include: a first accommodation part coupled to the inlet support part; a second accommodation part, having a diameter smaller than a diameter of the first accommodation part, which is inserted into and overlapped with the first accommodation part; and a third accommodation part, having a diameter smaller than the diameter of the second accommodation part, which is inserted into and overlapped with the second accommodation part, and wherein the accommodation parts may be added or removed depending on a size of the container unit.

The overall height of the first accommodation part to the third accommodation part of the recycling storage unit may be reduced by overlapping the first accommodation part to the third accommodation part as the amount of the beverage contained in the soft part decreases.

The combination set of eco-friendly recycling beverage container may further include: a transport box unit including a plurality of insertion holes arranged at regular intervals, each of the insertion holes having a hook protrusion by which the container unit inserted in the corresponding insertion hole may be hooked.

According to the present disclosure, it is possible to reduce the inconvenience in the storage and disposal process by allowing the entire height of the container to be reduced in accordance with the decrease in the amount of beverage in the storage container, and to suppress the insipidness phenomenon in the storage process by preventing the increase in empty space inside the container even when the beverage in the container is consumed, and to significantly reduce the use of environmental pollutants by using environmentally degradable materials instead of PET

### BRIEF DESCRIPTION OF THE DRAWINGS

FIG. 1 is a perspective view illustrating configurations of a combination set of eco-friendly recycling beverage container according to the present disclosure.

FIG. 2 is a view illustrating a cross-sectional structure of a container unit 100 for understanding the detailed structure of the container unit 100 shown in FIG. 1, which particularly shows a coupling structure of deformation preventing rods 22 coupled to a soft part 20 as an example.

FIG. 3 is a view illustrating a conceptualized cross-section of a state in which the container unit 100 shown in FIG. 1 is accommodated in and coupled to a recycling storage unit 200.

FIG. 4 is a view illustrating a conceptualized cross-section of a state in which the height of the container unit 100 and the recycling storage unit 200 is reduced due to a reduction of the beverage.

FIG. 5 is a cross-sectional view illustrating a state in which the container unit 100 shown in FIG. 1 is accommodated in and coupled to a transport box unit 300.

### DETAILED DESCRIPTION

The present disclosure should be interpreted to include the scope of rights that reach the technical idea through various modified embodiments, the present embodiments are merely provided to fully describe the present disclosure and completely inform those skilled in the art of the scope of the present disclosure, and the present disclosure is only defined by the scope of the claims.

Moreover, the accompanying drawings are provided to help supplementary understanding of the specific and detailed description of the present disclosure and do not represent the technical spirit of the present disclosure, but are merely a reference level.

In addition, a combination set of multi-stage overlapping type recycled drink container according to the present disclosure may be described in detail below as an embodiment, but it should not be interpreted that this embodiment reflects all the characteristic spirits of the present disclosure.

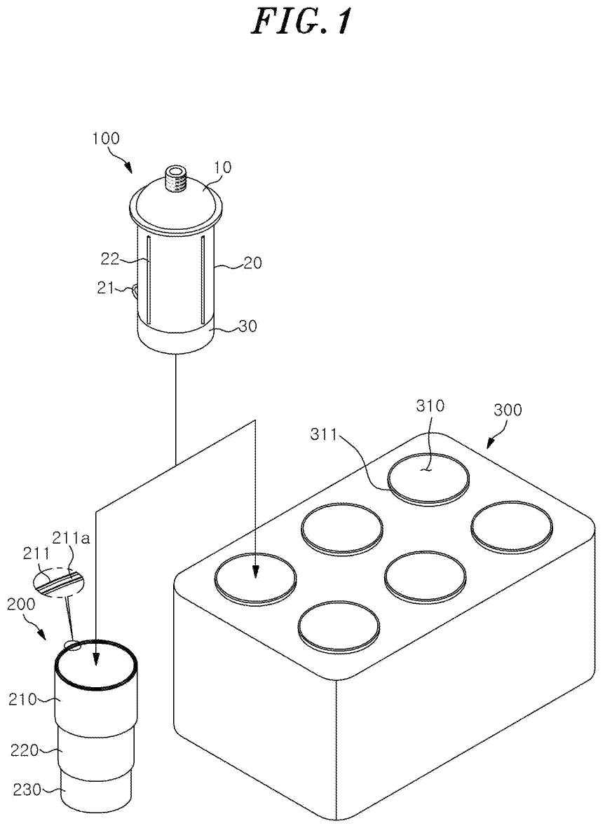

The combination set of eco-friendly recycling beverage container includes, for example, as shown in FIG. 1, a container unit 100 for accommodating beverage, and a recycling storage unit 200 having a structure to support the individual container unit 100 and a transport box unit 300 for accommodating a plurality of container units 100 in a supporting structure to facilitate the transportation of the plurality of container units 100 together.

The container unit 100 includes, as an example, as shown in FIG. 1, a soft part 20 for storing beverages which is made of eco-friendly vinyl or film that is flexible, foldable, harmless to a human body, and biodegradable compared to PET, an inlet support part 10 coupled to an upper end of the soft part 20 for convenience and basic shape maintenance when discharging beverages, and a bottom support part 30 coupled to a lower end of the soft part 20 to keep a bottom surface of the soft part 20 flat and support a load of the beverage.

The soft part 20, the inlet support part 10, and the bottom support part 30 may be coupled to each other using a mutual adhesive method as an example, but the present disclosure is not limited thereto and they may be coupled to each other using various methods.

The inlet support part 10 and the bottom support part 30 may be made of a plastic material such as PET (polyethylene terephthalate), but the present disclosure is not limited thereto. As a matter of course, the PET material is a fixed type and may maintain a rigidity, so that it may be suitable for use as a material of the inlet support part 10 and the bottom support part 30 of the container unit 100.

Meanwhile, a vinyl or film is softer than the PET material and may be flexibly deformed, such as being folded easily, so that it may be suitable for use as a material of the soft part 20 corresponding to the part for containing the beverage as the largest part of the container unit 100. The vinyl or film may be a biomass material of a biodegradable raw material obtained from naturally decomposable corn.

The biomass material may be formed of a mixture of components such as poly lactic acid (PLA), poly butylene succinate (PBS), polybutylene adipate-co-terephthalate (PBAT), and inorganic compounds, but it is not necessary to be limited to these material components, and other material components that are naturally decomposable may also be included. Through the use of such an eco-friendly material, it is possible to significantly reduce the use of a PET material for the container unit 100.

In addition, a finger ring 21 may be further coupled to a lower end of one outer surface of the soft part 20 to prevent inconvenience of pouring beverages due to deformation such as folding or bending caused by the flexibility of the soft part 20 in the process of tilting the container unit 100 to pour the beverage.

That is, when pouring beverage, if a user holds the inlet support part 10 with one hand and inserts a finger of the other hand into the finger ring 21, the user can pour the beverage easily and comfortably even when the soft part 20 is bent.

The finger ring 21 may be made of a flexible material such as vinyl or film so as not to become an obstacle when combining the container unit 100 with the recycling storage unit 200.

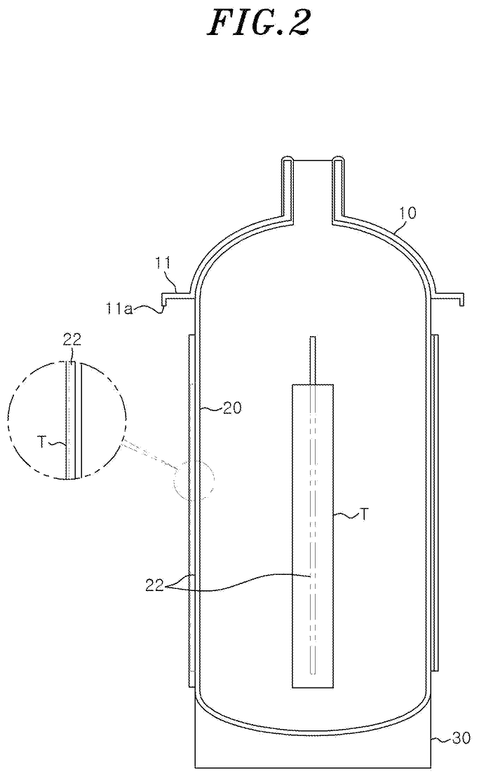

In addition, deformation prevention rods 22 may be coupled to the outer surface of the soft part 20 at regular intervals in a vertical arrangement structure, and the deformation prevention rods 22 are coupled to the soft part 20 preferably such that they can be easily removed from the soft part 20 so as not to become an obstacle when the container unit 100 is combined with the recycling storage unit 200. For example, it is preferable that the deformation prevention rods 22 are coupled to the soft part 20 through a tape adhesive manner as shown in FIG. 2, but the present disclosure is not limited thereto and may include various coupling ways.

That is, when the container unit 100 is provided alone without being combined with the recycling storage unit 200, the deformation prevention rods 22 are attached to the container unit 100 to prevent bending or collapse. Further, when the container unit 100 is opened and a part of the beverage therein is consumed and then the container unit 100 is to be combined with the recycling storage unit 200, the deformation prevention rod 22 may be removed so as not to be an obstacle in the combining process.

In this case, when the deformation prevention rods 22 are attached to the outer surface of the soft part 20 by putting the deformation prevention rods 22 on the outer surface of the soft part 20 and then adding an adhesive tape T having an easy-to-peel strength thereon, the deformation prevention rods 22 can be removed from the outer surface of the soft part 20, but the present disclosure is not necessarily limited to this method.

The deformation preventing rods 22 may be made of the same plastic material as the bottom support part 30, and may be formed to have a circular cross-section to maintain high strength in a small amount.

Due to the presence of the deformation preventing rods 22 and the bottom support part 30, even when the container unit 100 is provided alone without being combined with the recycling storage unit 200, the soft part 20 may be prevented from being bent or collapsed.

Meanwhile, at a lower end of the inlet support part 10, a fitting flange 11, which has a diameter larger than that of the immediately upper portion and has a fitting protrusion 11a at its edge, may be further formed. The fitting flange 11 is provided for binding to an upper end of the recycling storage unit 200 in a fitting structure.

The recycling storage unit 200 may be formed in one stage or multiple stages depending on an initial height of the container unit 100, and when it is configured in multiple stages, advantages such as reduction of PET use, reduction of volume, and prevention of insipidness phenomenon may be obtained, and even in the case that it is configured in one stage, the use of PET may be reduced.

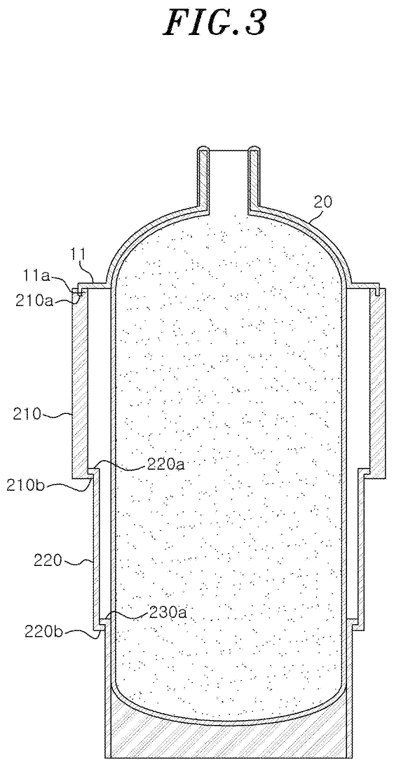

For example, the recycling storage unit 200 may have a three-stage overlapping structure for the container unit 100 having a capacity of 1.5 liters. In this case, as shown in FIGS. 1 and 3, the recycling storage unit 200 may have a first accommodation part 210 provided at an upper portion thereof, a second accommodation part 220 inserted into the first accommodation part 210 to be overlapped and having a diameter smaller than a diameter of the first accommodation part 210, and a third accommodation part 230 inserted into the second accommodation part 220 to be overlapped and having a diameter smaller than the diameter of the second accommodation part 220.

Further, when the first accommodation part 210, the second accommodation part 220, and the third accommodation part 230 are extended up and down, in order to have a mutually engaging function, a lower end of the first accommodation part 210, upper and lower ends of the second accommodation part 220, and an upper end of the third accommodation part 230 may be configured to include locking edge 210b, locking edges 220a and 220b, and a locking edge 230a, respectively. In addition, a fitting groove 210a that can be fitted onto the fitting protrusion 11a of the fitting flange 11 provided at the lower end of the inlet support part 10 may be provided at an upper end of the first accommodation part 210. The upper end of the first accommodation part 210 in which the fitting groove 210a is provided may be referred to as a fitting edge.

That is, the upper end of the first accommodation part 210 includes the fitting edge of an enlarged diameter structure having the fitting groove 210a, and the lower end of the first accommodation part 210 includes the locking edge of a reduced diameter structure in which a first locking protrusion 210b is provided. Further, the upper end of the second accommodation part 220 includes the locking frame of an enlarged diameter structure having a second locking protrusion 220a that can be hooked on the first locking protrusion 210b, and the lower end of the second accommodation part 220 includes the locking frame of a reduced diameter structure having a third locking protrusion 220b. Furthermore, the upper end of the third accommodation part 230 includes the locking frame of an enlarged diameter structure having a fourth locking protrusion 230a that can be hooked on the third locking protrusion 220b. In this case, a bottom surface of the third accommodation part 230, which is the lowest accommodation part, may be in an open state rather than a closed structure.

The first accommodation part 210, the second accommodation part 220, and the third accommodation part 230 of the recycling storage unit 200 may be operated in a direction in which they are overlapped with each other to reduce the overall height in accordance with the decrease in the volume of the soft part 20 as the beverage contained in the soft part 20 of the container unit 100 of 1.5 liters is consumed, for example.

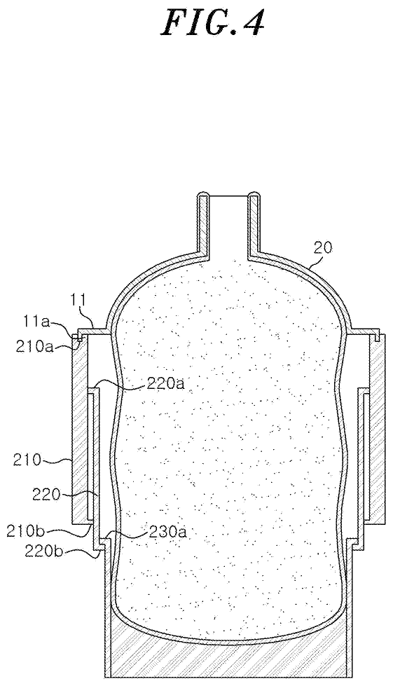

In other words, as the third accommodation part 230 of the recycling storage unit 200 is inserted into and overlapped with the second accommodation part 220, and the second accommodation part 220 is inserted into and overlapped with the first accommodation part 210, the overall height of the container unit 100 decreases as shown in FIG. 4. In this way, it is possible to increase the convenience of storing the remaining beverage after drinking, and the empty space inside the soft part 20 does not increase even after the beverage is consumed, so that the insipidness phenomenon can be prevented.

Meanwhile, the recycling storage unit 200 is reusable, and thus, after obtaining the recycling storage unit 200 once by purchasing it in combination with the container unit 100 or purchasing it independently, a user who purchases a product having the container unit 100 may store the container unit 100 in combination with the obtained recycling storage unit 200 by removing the deformation prevention rods 22 while opening the product. In addition, after consuming all the beverages, the convenience in the disposal process can be increased by separating the container unit 100 from the recycling storage unit 200 again and trashing only the container unit 100 with the size greatly reduced. In this way, by reusing the recycling storage unit 200, the use of PET may be significantly reduced.

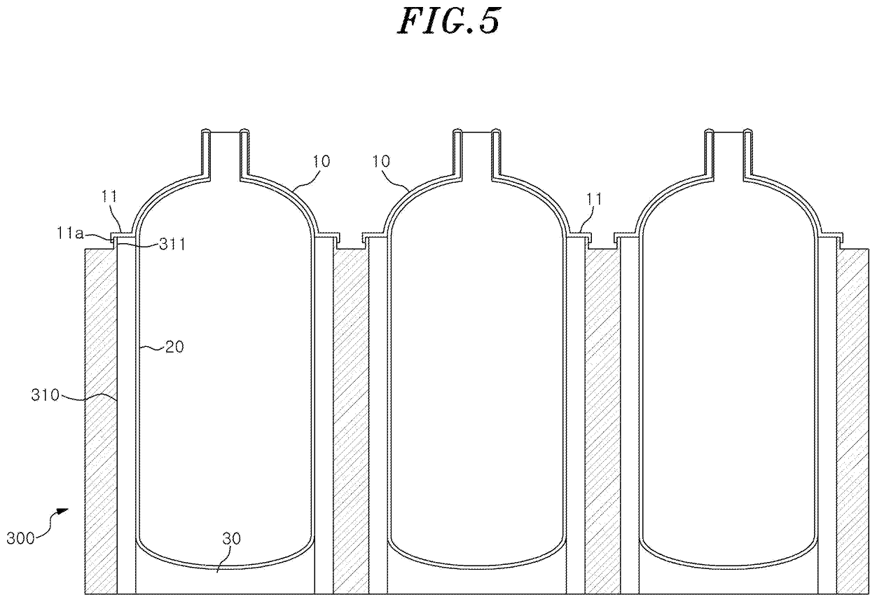

Meanwhile, when transporting or placing a plurality of container units 100 at once, as shown in FIGS. 1 and 5, a method in which the plurality of container units 100 are bound to the transport box unit 300 may be taken.

As a matter of course, besides the accommodation in the transport box unit 300, a single container unit 100 may be stored or sold in a state in which the deformation prevention rods 22 are attached to the single container unit 100, and a single container unit 100 individually bound to the recycling storage unit 200 may be stored or sold.

The transport box unit 300 may have a box-shaped structure, and a plurality of insertion holes 310 into which a plurality of container units 100 may respectively be accommodated may be arranged at regular intervals, and the transport box unit 300 may be made of thick paper or the like as well as a plastic material.

Each of the insertion holes 310 may be configured to have a structure in which a hook protrusion 311 for hooking the fitting flange 11 formed at the inlet support part 10 of the container unit 100 protrudes by a predetermined length. Accordingly, a plurality of container units 100 are bound in such a way that they are accommodated respectively in the insertion holes 310 of the transport box unit 300, thereby suppressing the movement of individual products during transport or storage to reduce the risk of damage and increase work efficiency.

In addition, the container unit 100 including the soft part 20, the inlet support part 10, and the bottom support part 30, the recycling storage unit 200 including the first accommodation part 210 to the third accommodation part 230, and the insertion holes 310 of the transport box unit 300 are illustrated in a circular structure in the accompanying drawings, but may have various structural shapes such as polygons without being limited to such a circular structure.

What is claimed is:

1. A combination set of eco-friendly recycling beverage container, the combination set comprising:
a container unit including a soft part that folds and bends with greater softness than softness of plastic or glass and stores a beverage therein, an inlet support part coupled around a beverage outlet at an upper end of the soft part, and a bottom support part coupled to a lower end of the soft part; and
a recycling storage unit configured to accommodate and bind the container unit, the recycling storage unit having a multi-stage overlapping structure in which an overall height is reduced depending on a degree of reduced amount of the beverage contained in the container unit,
wherein the soft part is formed of a biomass material that is naturally decomposable, and a fitting flange of an enlarged structure having a fitting protrusion is formed at a lower end of the inlet support part, and a soft finger ring is provided at a position of a lower outer surface of the soft part to prevent inconvenience caused by the bending of the soft part in a process of tilting the container unit to pour the beverage,
wherein a plurality of deformation preventing rods are coupled to the soft part in a vertical structure at a predetermined interval along an outer surface of the soft part to prevent the container unit from collapsing or bending due to a flexibility of the soft part when the container unit containing the beverage is provided alone, and
wherein the plurality of deformation prevention rods are detachable from the outer surface of the soft part.

2. The combination set of eco-friendly recycling beverage container of claim 1, wherein the biomass material of the soft part is a mixture of material components including poly lactic acid (PLA), polybutylene succinate (PBS), polybutylene adipate-co-terephthalate (PBAT), and inorganic compound, and the inlet support part and the bottom support part are formed of polyethylene terephthalate (PET) and the deformation prevention rods are formed of a plastic material.

3. The combination set of eco-friendly recycling beverage container of claim 1, wherein the recycling storage unit has a single-stage or multi-stage structure with top and bottom opened, and is formed of a material of PET.

4. The combination set of eco-friendly recycling beverage container of claim 3, wherein an upper end of the recycling storage unit is fitted onto the fitting protrusion of the inlet support part.

5. The combination set of eco-friendly recycling beverage container of claim 4, wherein the recycling storage unit of the multi-stage structure includes:
a first accommodation part coupled to the inlet support part;
a second accommodation part, having a diameter smaller than a diameter of the first accommodation part, which is inserted into and overlapped with the first accommodation part; and
a third accommodation part, having a diameter smaller than the diameter of the second accommodation part, which is inserted into and overlapped with the second accommodation part, and
wherein the accommodation parts are added or removed depending on a size of the container unit.

6. The combination set of eco-friendly recycling beverage container of claim 5, wherein the overall height of the first accommodation part to the third accommodation part of the recycling storage unit is reduced by overlapping the first accommodation part to the third accommodation part as the amount of the beverage contained in the soft part decreases.

7. The combination set of eco-friendly recycling beverage container of claim 1, further comprising:
a transport box unit including a plurality of insertion holes arranged at regular intervals, each of the insertion holes having a hook protrusion by which the container unit inserted in the corresponding insertion hole is hooked.
